(19) United States
(12) Patent Application Publication
(10) Pub. No.: US 2003/0184666 A1
(43) Pub. Date: Oct. 2, 2003

(54) Image sensor having pixel array and method for automatically compensating black level of the same

(76) Inventor: Wan-Hee Jo, Ichon-shi (KR)

Correspondence Address: BIRCH STEWART KOLASCH & BIRCH, PO BOX 747, FALLS CHURCH, VA, 22040-0747, US

(21) Appl. No.: 10/330,239

(22) Filed: Dec. 30, 2002

(30) Foreign Application Priority Data
Mar. 29, 2002 (KR) 2002-17263

(51) Int. Cl. H04N 5/335

(52) U.S. Cl. 348/308

(57) ABSTRACT

The presentc invention provides a pixel array of an image sensor, an image sensor having the same and a method for automatically compensating a black level of an image sensor. The inventive image sensor is able to prevent degradation of properties of the image sensor with regardless of applied conditions. To achieve this effect, an image sensor having a pixel array, includes: a first pixel group including N and M numbers of unit pixels, where N and M are integers; and a second pixel group being arrayed in one and the other sides of the first pixel group in a column direction so as to evaluate an offset value of a black level with respect to the unit pixels.

### FIELD OF THE INVENTION

The present invention relates to an image sensor; and, more particularly, to an image sensor having a pixel array and a method for automatically compensating a black level of the image sensor so as to prevent degradation of properties of the image sensor with regardless of applied conditions.

### DESCRIPTION OF RELATED ARTS

Image sensor is a device that generates an image by using a characteristic of a semiconductor that has reactivity to light. That is, it is a device that reads detections captured by a pixel included in the image sensor, which senses various intensity levels and wavelengths of lights emitted from different objects, as electric values. Particularly, it is the function of the image sensor to convert the electric value into a level enabled with a signal processing.

In other words, the image sensor is a semiconductor device that converts an optical image into an electric signal. A charge coupled device (CCD) is a device wherein each individual metal-oxide silicon (hereinafter referred as to MOS) capacitor is closely placed to each other, and charge carriers are stored into the MOS capacitor and transferred. A complementary metal-oxide semiconductor (hereinafter referred as to CMOS) image sensor is a device that makes MOS transistors as the same number of existing pixels by employing CMOS technology that uses a control circuit and a signal processing circuit as periphery circuits and adopts a switching mode that detects outputs sequentially.

The CMOS image sensor can be usefully applied to a personal portable system such like a cellular phone since it has an advantage of low power dissipation.

Accordingly, the image sensor has further various applications used for PC cameras, toys and medical purposes.

FIG. 1 is a block diagram showing an image sensor in accordance with a prior art.

Referring to FIG. 1, a conventional image sensor includes a control and external system interface unit 10, a pixel array unit 11, an analog line buffer unit 12, a column decoder 13A, a row decoder 13B, a programmable gain amplifier (hereinafter referred as to PGA) 14 and an analog to digital converter 15 (hereinafter referred as to ADC).

Hereinafter, operations of the constitutional elements of the image sensor will be described in detail.

The pixel array unit 11 arrays horizontally N numbers of pixels and vertically M numbers of pixels, where N and M are integers, in order to maximize reactivity to light. The pixel array unit 11 is also an essential element of the image sensor because it detects information related to images inputted from an external environment. The control and external system interface unit 11 controls an overall operation of the image sensor by using a finite state machine (FSM) and enacts as an interface to the external system. Furthermore, the control and external system interface unit 11 is able to program information related to various internal operations due to a batch register (not shown), and also controls operations of a whole chip in accordance with the programmed information.

The analog line buffer unit 12 detects and stores voltages of pixels in a selected row. One analog datum value is selected among analog data stored into the analog line buffer unit 12 through a control of the column decoder 13A and the row decoder 13B and transmitted to the PGA 14 through an analog bus.

When the pixel voltage stored in the analog line buffer line 12 is low, the PGA 14 amplifies the voltage. The selected analog datum that passed through the PGA 14 is proceeded with color interpolation and color correction procedures, and then converted to a digital value through the ADC 15.

There occurs fixed pattern noises in the image sensor due to an offset voltage resulted from a micro-difference in an image sensor fabrication process. To compensate the fixed pattern noise, the image sensor uses a correlated double sampling (CDS) technique that reads a reset voltage signal in each pixel of the pixel array unit 11 and a data voltage signal and then outputs the difference between the two signals.

Meanwhile, although a kinetic temperature of the image sensor typically ranges from about 0° C. to about 40° C., the image sensor should operate without any degradation of properties even above about 60° C. However, since the image sensor is also constituted with a semiconductor device, currents are generated due to a thermal effect at a high temperature. Hence, when theses currents, i.e., dark currents are generated, a signal component is also included in the image sensor in addition to optical components. As a result of this signal component, a consistent degree of signal level is detected in a very dark environment, i.e., even in case that no light is shined through. The detected signal level is called a black level, which is a critical factor for inducing thermal noises and system noises.

Therefore, since there always exists the black level in the conventional image sensor, the image sensor has certain restrictions in applicable conditions and a problem of degradation in properties of the image sensor.

### SUMMARY OF THE INVENTION

It is, therefore, an object of the present invention to provide a pixel array of an image sensor capable of preventing degradation of properties with regardless of applied conditions and an image sensor having the same.

Also, it is another object of the present invention to provide a method for automatically compensating a black level of an image sensor.

In accordance with an aspect of the present invention, there is provided an image sensor having a pixel array, comprising: a first pixel group including N and M numbers of unit pixels, where N and M are integers; and a second pixel group being arrayed in one and the other sides of the first pixel group in a column direction so as to evaluate an offset value of a black level with respect to the unit pixels.

In accordance with another aspect of the present invention, there is also provided an image sensor, comprising: a pixel array unit including a first pixel group having N and M numbers of unit pixels and a second pixel group being arrayed in one and the other sides of the first pixel group in a column direction for evaluating an offset value of a black level with respect to the unit pixels; and an offset adjusting unit for eliminating offset changes due to the black level by changing an offset value of the first pixel group according to an offset value of the black level.

In accordance with still another aspect of the present invention, there is also provided a method for automatically compensating a black level of an image sensor that includes a pixel array unit having a first pixel group for sensing an image and a second pixel group for compensating a black level, comprising the steps of: evaluating an offset value of a black level with respect to the second pixel group; determining an offset value updated by the offset value of the black level and an initial offset value; and compensating the black level by adding the updated offset value and image data with respect to the first pixel group.

With currently used technologies, it is nearly impossible to develop a pixel array that does not generate a black level. However, the black level has a characteristic of shifting overall signal elements according to a temperature, e.g., the signal elements are shifted upwards in overall as the temperature increases. Based on this characteristic, the black level is firstly evaluated and compensated as the same degree of the black level in an actual pixel signal by using an analog to digital converter (ADC) offset function. Therefore, it is possible to minimize degradation of properties of the image sensor due to the black level increased by changes in applied conditions.

### BRIEF DESCRIPTION OF THE DRAWINGS(S)

The above and other objects and features of the present invention will become apparent from the following description of the preferred embodiments given in conjunction with the accompanying drawings, in which:

FIG. 1 is a block diagram illustrating an image sensor in accordance with a prior art;

FIG. 2 is a plane view showing a pixel array unit of an image sensor in accordance with a preferred embodiment of the present invention;

FIG. 3 is a block diagram illustrating an image sensor including the pixel array unit in accordance with the present invention; and

FIGS. 4 and 5 are schematic block diagrams for describing a method for automatically compensating a black level in accordance with the present invention.

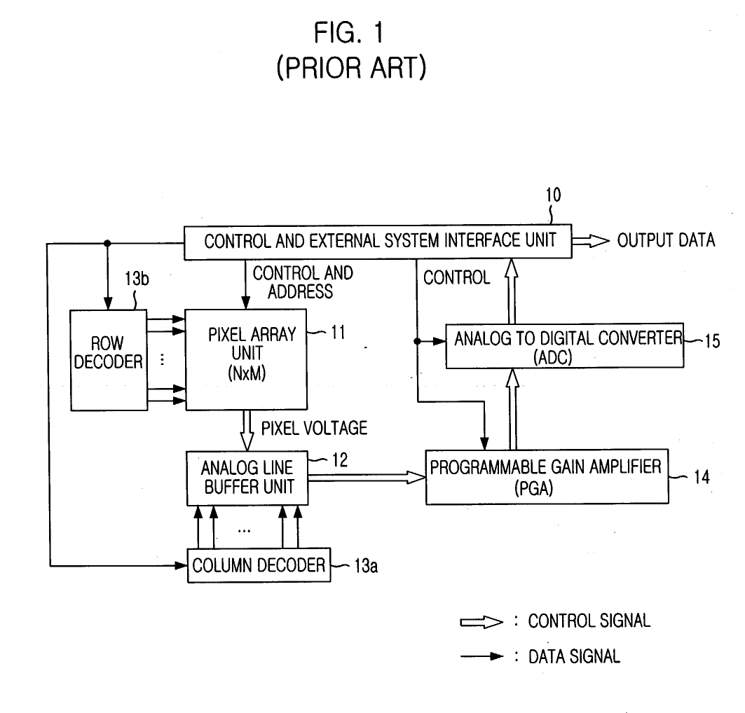

### DETAILED DESCRIPTION OF THE INVENTION

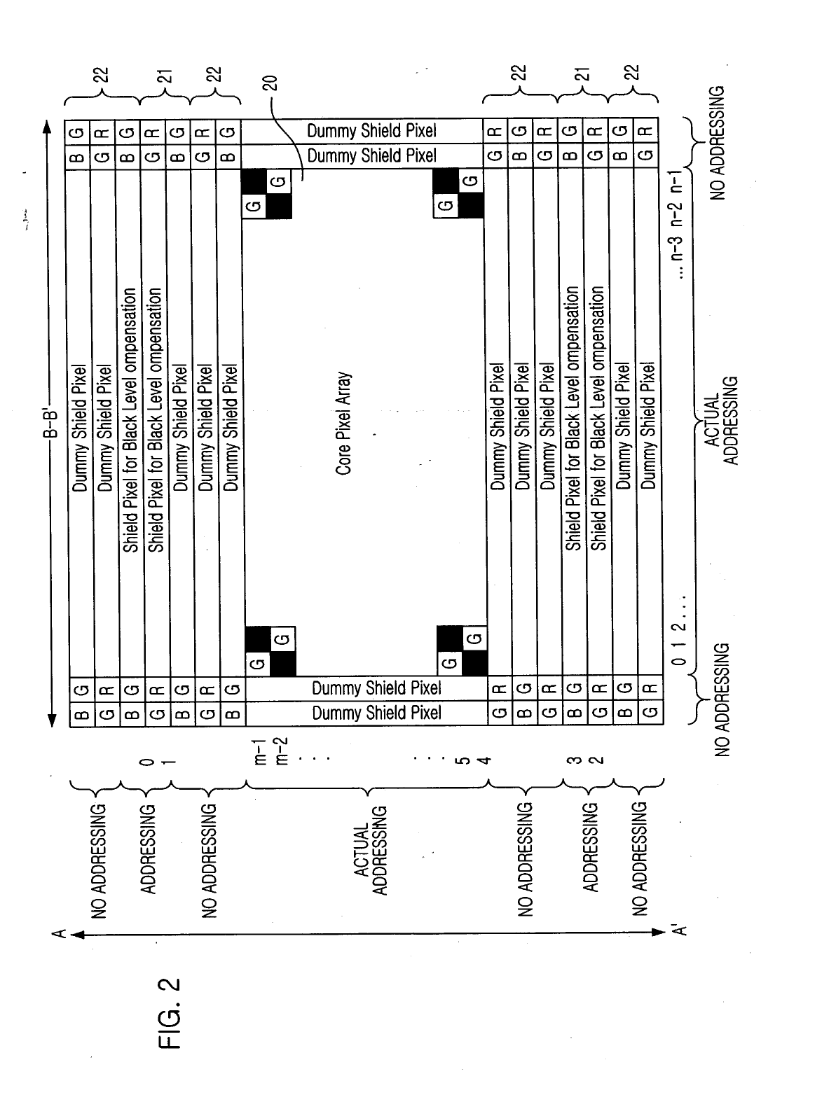

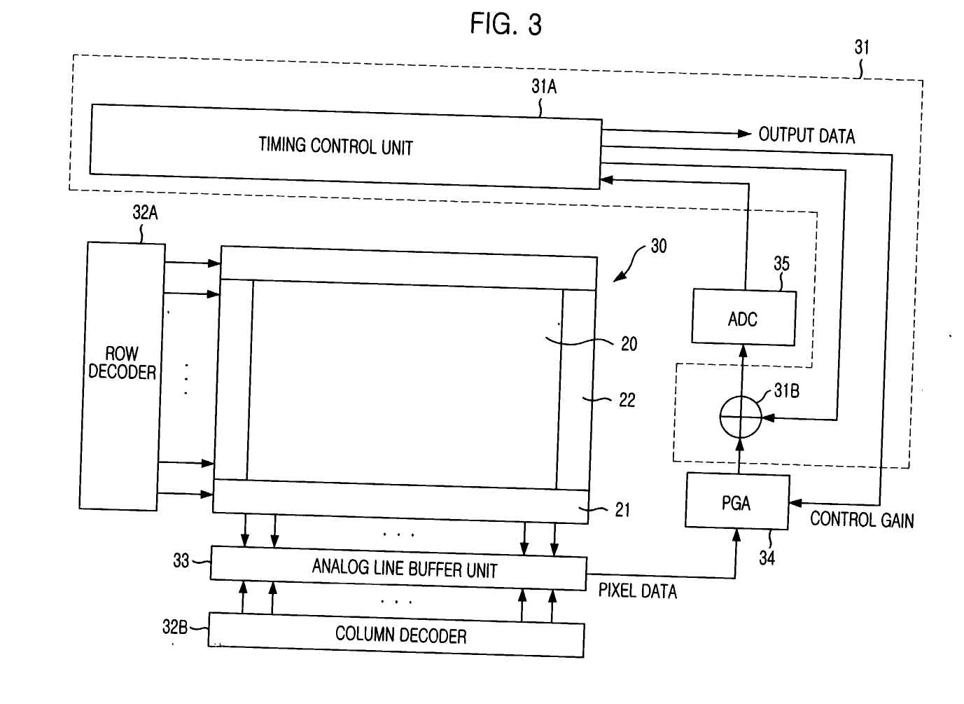

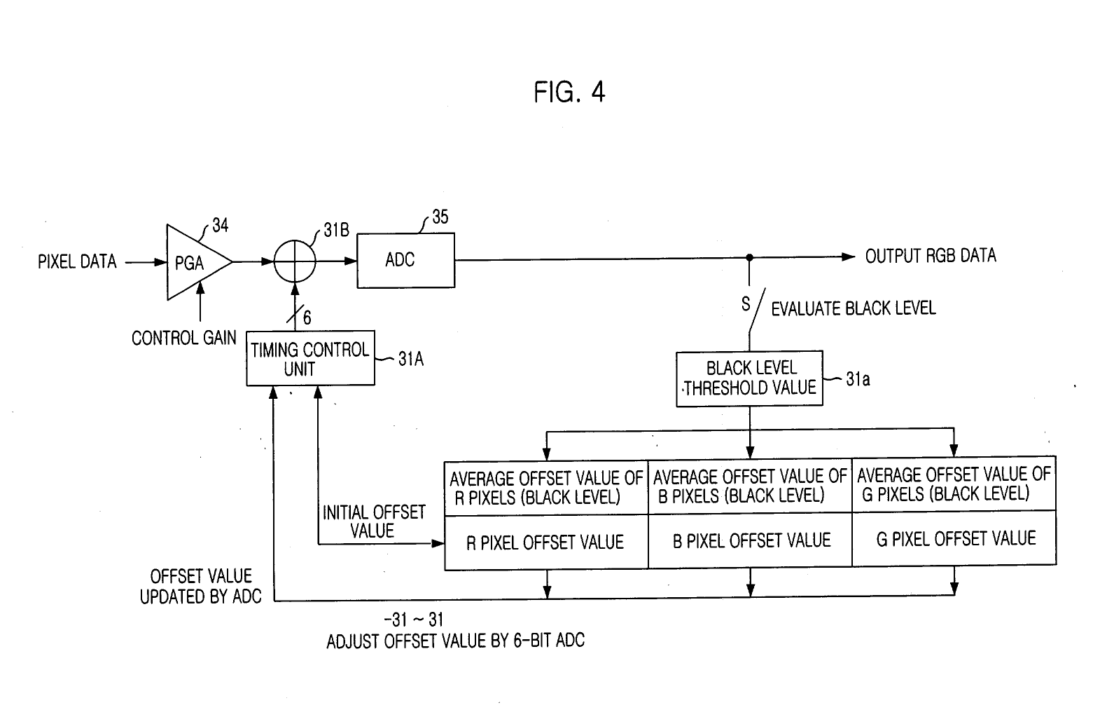

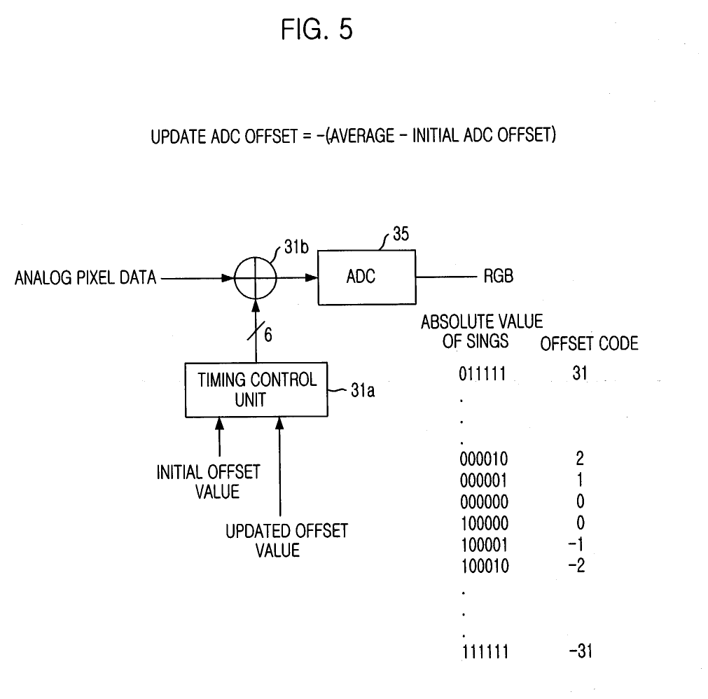

FIG. 2 is a plane view showing a pixel array unit of an image sensor in accordance with a preferred embodiment of the present invention. FIG. 3 is a block diagram illustrating an image sensor including the pixel array unit in accordance with the present invention. Also, FIGS. 4 and 5 are schematic block diagrams for describing a method for automatically compensating a black level.

Referring to FIG. 2, a pixel array unit includes a first pixel group 20, e.g., core pixel array, and a second pixel group 21 arrayed in one and the other sides of the first pixel group 20 in a direction of A-A′ for evaluating an offset value of a black level with respect to pixels included in the second pixel group 21.

The above offset value is an average value of total pixels included in the second pixel group 21. Also, the pixel array unit includes a third pixel group 22, e.g., a dummy pixel array, arrayed in between the first pixel group 20 and the second pixel group 21 and outer sides of the second pixel group 21 for shielding incident lights from entering to the second pixel group 21. The third pixel group 22 does not have addresses. Meanwhile, a dummy shield pixel is typically used for shielding incident lights from entering to areas other than the pixel array due to a blooming effect of the pixel array unit. However, this dummy shield pixel in the present invention has a different function from the third pixel group 22.

For more detailed description on the pixel array unit, the shielded second pixel group 21, i.e., shield pixel array line, is arrayed at top and bottom of the first pixel group 20, and the third pixel group 22 encompasses the second pixel group 21 for a complete shield from lights. Although the third pixel group 22 has an identical structure to a unit pixel of the first pixel group 20, the third pixel group 22 dose not have a specific address assigned, and thus, has unrelated operational schemes to the first pixel group 20.

Also, even though the second pixel group 21 for detecting the black level is arrayed at the top and bottom of the first pixel group 20, the second pixel group 21 performs an addressing function in first. For example, since the second pixel group 21 addresses in an order from 0 to m−1, the addresses from 0 to 3 access the second pixel group 21.

Herein, pixel rows for the second pixel group 21 and the third pixel group 22 are set to be 4 and 10, respectively. However, more of pixel rows can be arrayed for precisely evaluating the black level.

FIG. 3 is a plane view showing an image sensor including the pixel array unit for compensating the black level.

Referring to FIG. 3, the image sensor in accordance with the present invention includes a pixel array unit 30 including the first pixel group 20, i.e., the core pixel array, that arrays horizontally N numbers of pixels and vertically M numbers of pixels, where N and M are integers, to detects information on an image inputted from an external environment, the second pixel group 21 arrayed in one and the other sides of the first pixel group 20 for evaluating an offset value of a black level with respect to pixels of the second pixel group 21 and the third pixel group 22 for shielding lights and an offset adjusting unit 31 for eliminating offset changes due to the black level by changing an offset value of the second pixel group 21 according to an offset value of the black level.

In more detail, the image sensor also includes an analog line buffer unit 33 that buffers a signal transmitted from the pixel array unit 30, a programmable gain amplifier (hereinafter referred as to PGA) 34 for amplifying outputs of the analog line buffer unit 33, i.e., pixel data, an analog to digital converter (hereinafter referred as to ADC) 35, a row decoder 32A and a column decoder 32B. Particularly, the offset adjusting unit 31 further includes a timing control unit 31A for properly applying timing of offset values updated for each color of red (R), green (G) and blue (B) according to a difference between the evaluated offset value of the black level and an initial offset value and an addition unit 31B for compensating analog data by adding the updated offset value provided from the timing control unit 31A and the analog pixel data from the first pixel group 20.

The analog line buffer unit 33 detects and stores voltages of pixels in a selected row. The PGA 34 amplifies the pixel voltage when the pixel voltage stored in the analog line buffer unit 33 is low. Then, the analog data passed through the PGA 34 is converted and outputted as a digital value through the ADC 35. Herein, it is possible to control gains of each R, G and B for compensating color interpolation and color correction.

With reference to FIGS. 4 to 5, operations for automatically compensating the black level in the image sensor will be described in detail.

First, columns corresponding to addresses from o to 3, that is, an average value of the black level with respect to the second pixel group 21 is evaluated. Subsequently, an updated offset value is determined by using the average value and an initial offset value of the ADC 35 used also for the average value. Thereafter, the updated offset value is added to image data with respect to the first pixel group 20 so as to compensate the black level.

Concretely, referring to the pixel array unit of FIG. 2, lines corresponding to the addresses from 0 to 3 are firstly read, and then, an average value of pixels corresponding to each of R, G and B considered with an initial offset value in a step of adjusting the offset value is calculated. There is no difference in structures of these pixels for R, G and B because they are completely shielded from color filters and light sources. However, the offset values of these pixels are different since the PGA 34 controls each gain of R, G and B.

Each average value of pixels for each of the R, G and B represents a black level value of whole pixels. That is, the average value of pixels for each of R, G and B should be closed to 0 in a normal state. However, these pixels have certain average values when the black level effect occurs, and the average value is subtracted from the pixels for compensating the black level effect when actually reading regular pixels.

When reading the second pixel group 21 for compensating the initial black level, the initial offset value is taken into a consideration for evaluating each average value of pixels for each of R, G and B, and then, the offset value is updated by using the average value so as to compensate the black level when reading actual pixels.

An offset value of the ADC 35 can control from about −31 to about 31, expressed in 6 bits with a singed magnitude mode. At this time, a most significant bit (MOS) is a sign bit. For instance, when the number 0 and 1 mean “+” and “−” signs, respectively. Also, a bit of [4:0] is an absolute value of the signal, meaning a magnitude of the signal.

Herein, the ADC 35 is limited to be 8 bits. In case that the ADC 35 is 10 bits, it is still expressed in 8 bits, and thus, the magnitude of the bit changes in accordance with the ADC 35.

Therefore, the updated offset value of the ADC 35 is determined based on the each calculated average value in accordance with an equation as:

Update ADC offset=−(Average−Initial ADC offset)

Herein, ‘Update ADC offset’, ‘Average’ and ‘Initial ADC offset’ represent an updated offset value, an average value of the black level and initially set offset value, respectively.

As shown in FIG. 5, while evaluating an offset value of the black level for 4 lines in the pixel array unit, i.e., column address from 0 to 3, a black level evaluation switch ‘S’ is turned on and each average value of pixels for each of R, G and B are estimated based on shielded pixels. Then, each offset value for each R, G and B is also estimated based on the evaluated average value and the initial offset value and stored subsequently. Each of the offset values is used for estimating pixel data value of the second pixel group. At this time, the timing control unit 31A outputs an offset value in accordance with timing for each R, G and B pixels so as to obtain the pixel data compensated with the black level.

The block 31A, expressed in a black level threshold value in FIG. 4, is placed before evaluating the average value in order not to include potential dead pixels for the evaluation of the average value. That is, the black level threshold value 31A eliminates values above a threshold.

Also, the initial offset value is unnecessary for evaluating the black level. However, in case that the initial value has a positive value, it is possible to compensate not only the black level but also other types of errors such as system noises.

As shown in the preferred embodiment of the present invention, it is possible to retain consistently a certain characteristic of the image sensor with regardless of applied conditions through the application of typically used pixels by manipulating a simple digital logic so to automatically estimate and compensate the offset value of the black level that increases as a temperature increases.

Due to the retained characteristic of the image sensor makes it possible to broaden fields of application of the image sensor, and thus, makes the image sensor to become more competitive to other types of image sensors.

While the present invention has been described with respect to certain preferred embodiments, it will be apparent to those skilled in the art that various changes and modifications may be made without departing from the scope of the invention as defined in the following claims.

What is claimed is:

1. An image sensor having a pixel array, comprising:
a first pixel group including N and M numbers of unit pixels, where N and M are integers; and
a second pixel group being arrayed in one and the other sides of the first pixel group in a column direction so as to evaluate an offset value of a black level with respect to the unit pixels.

2. The pixel array unit of the image sensor as recited in claim 1, wherein the offset value is an average value with respect to offset values of whole pixels in the second pixel group.

3. The pixel array unit of the image sensor as recited in claim 1, further comprising a third pixel group being arrayed in between the first pixel group and the second pixel group and also outer sides of the second pixel group so as to shield incident lights from entering to the second pixel group.

4. The pixel array unit of the image sensor as recited in claim 3, wherein the third pixel group does not have addresses.

5. An image sensor, comprising:
a pixel array unit including a first pixel group having N and M numbers of unit pixels and a second pixel group being arrayed in one and the other sides of the first pixel group in a column direction for evaluating an offset value of a black level with respect to the unit pixels; and
an offset adjusting unit for eliminating offset changes due to the black level by changing an offset value of the first pixel group according to an offset value of the black level.

6. The image sensor as recited in claim 5, wherein the offset value of the black level is an average of the offset values of the black level with respect to whole pixels in the second pixel group.

7. The image sensor as recited in claim 5, further comprising a third pixel group being arrayed in between the first pixel group and the second pixel group and also outer sides of the second pixel group so as to shield incident lights from entering to the second pixel group.

8. The image sensor as recited in claim 7, wherein the third pixel group does not have addresses.

9. The image sensor as recited in claim 5, wherein the offset adjusting unit includes:
a timing control unit for applying timing of offset values for each color of red (R), green (G) and blue (B) updated in accordance with a difference between the evaluated offset value of the black level and an initial offset value.

10. A method for automatically compensating a black level of an image sensor that includes a pixel array unit having a first pixel group for sensing an image and a second pixel group for compensating a black level, comprising the steps of:
evaluating an offset value of a black level with respect to the second pixel group;
determining an offset value updated by the offset value of the black level and an initial offset value; and
compensating the black level by adding the updated offset value and image data with respect to the first pixel group.

11. The method as recited in claim 10, wherein the offset value of the black level is an average of offset values of the black level with respect to whole pixels in the second pixel group.

12. The method as recited in claim 10, wherein the initial offset value can be controlled externally.
